(19) United States
(12) Patent Application Publication
(10) Pub. No.: US 2022/0410746 A1
(43) Pub. Date: Dec. 29, 2022

(54) ELECTRICITY SUPPLY SYSTEM AND ELECTRICITY SUPPLY METHOD

(71) Applicant: Toyota Jidosha Kabushiki Kaisha, Toyota-shi Aichi-ken (JP)

(72) Inventor: Kazuki Kubo, Toyota-shi Aichi-ken (JP)

(73) Assignee: Toyota Jidosha Kabushiki Kaisha, Toyota-shi Aichi-ken (JP)

(21) Appl. No.: 17/751,808

(22) Filed: May 24, 2022

(30) Foreign Application Priority Data
Jun. 29, 2021 (JP) 2021-107363

(51) Int. Cl. B60L 53/36; B60L 58/12; B60W 60/00

(52) U.S. Cl. CPC B60L 53/36; B60L 58/12; B60W 60/001; B60W 30/06

(57) ABSTRACT

In an electricity supply system including a plurality of pieces of electricity supply equipment and a plurality of vehicles, when a second vehicle being supplied with electricity from first electricity supply equipment receives a request to surrender the first electricity supply equipment from a first vehicle, the second vehicle surrenders the first electricity supply equipment to the first vehicle and moves, through automated driving, to second electricity supply equipment selected from among the plurality of pieces of electricity supply equipment when the second vehicle is able to travel as far as the second electricity supply equipment.

### CROSS-REFERENCE TO RELATED APPLICATION

This application claims priority to Japanese Patent Application No. 2021-107363 filed on Jun. 29, 2021, incorporated herein by reference in its entirety.

### BACKGROUND

### 1. Technical Field

The present disclosure relates to an electricity supply system and an electricity supply method and, more particularly, to a technique of supplying electricity to a vehicle.

### 2. Description of Related Art

Japanese Patent No. 5475407 discloses electricity supply equipment that can be housed under the ground (hereinafter, also referred to as “underground electricity supply equipment”). The underground electricity supply equipment disclosed in Japanese Patent No. 5475407 includes a base pole (fixed part) and a charging pole (movable part). A user can extract the charging pole above the ground by holding a handle provided on a top face (upper-side portion) of the charging pole housed under the ground and pulling up the charging pole.

### SUMMARY

In recent years, electricity supply systems adopting underground electricity supply equipment and automated driving vehicles have been proposed. However, for an electricity supply system using many automated driving vehicles, there is a possibility that the number of pieces of electricity supply equipment becomes insufficient for the number of vehicles. A vehicle may be unable to travel according to a planned schedule if the vehicle waits for a long time because electricity supply equipment that the vehicle intends to use is occupied when the vehicle arrives at the electricity supply equipment.

The present disclosure has been made to solve such a problem, and an object thereof is to provide an electricity supply system and an electricity supply method that can restrain a vehicle from being excessively behind a planned traveling schedule.

An electricity supply system according to a first aspect of the present disclosure includes a plurality of pieces of electricity supply equipment and a plurality of vehicles including a first vehicle and a second vehicle. When the second vehicle being supplied with electricity from first electricity supply equipment included in the plurality of pieces of electricity supply equipment receives a request to surrender the first electricity supply equipment from the first vehicle, the second vehicle surrenders the first electricity supply equipment to the first vehicle and moves, through automated driving, to second electricity supply equipment selected from among the plurality of pieces of electricity supply equipment when the second vehicle is able to travel as far as the second electricity supply equipment.

According to such a configuration, if the second vehicle can travel as far as the second electricity supply equipment when requested by the first vehicle to surrender the first electricity supply equipment, the second vehicle surrenders the first electricity supply equipment to the first vehicle and moves to the second electricity supply equipment. Thus, a wait time of the first vehicle is shortened, and the first vehicle is restrained from being excessively behind a planned traveling schedule. Moreover, the second vehicle can be supplied with electricity from the second electricity supply equipment instead of the first electricity supply equipment.

Each of the first vehicle and the second vehicle may be an automated driving vehicle configured to be capable of driverless traveling according to a predetermined traveling schedule.

Examples of such vehicles include a movable shop vehicle, an automatic guided vehicle (AGV), and a robotaxi. It becomes easier for such vehicles to travel according to planned schedules, whereby a highly convenient infrastructure can be easily constructed, for example, in a smart city.

Each of the first vehicle and the second vehicle may include an electricity storage device that is chargeable with electricity externally supplied, and may be configured to travel by using the electricity stored in the electricity storage device. The first vehicle may be configured to acquire SOC of the electricity storage device of the second vehicle and, when the SOC of the electricity storage device of the second vehicle is higher than SOC of the electricity storage device of the first vehicle, to request the second vehicle to surrender the first electricity supply equipment.

The state of charge (SOC) indicates remaining electricity stored and expresses, for example, a proportion of an amount of electricity currently stored to an amount of electricity stored in a full charge state, from 0 to 100%. Hereinafter, the SOC of the electricity storage device of the first vehicle is also referred to as “SOC of the first vehicle”, and the SOC of the electricity storage device of the second vehicle is also referred to as “SOC of the second vehicle”.

With such a configuration, when the SOC of the second vehicle is lower than the SOC of the first vehicle, the first vehicle does not request the second vehicle to surrender the electricity supply equipment. Thus, traveling of a vehicle with the lower-SOC electricity storage device is restrained, so that vehicles running out of electricity are less likely to exist.

The first vehicle may be configured to acquire the SOC of the electricity storage device of the second vehicle from the second vehicle through vehicle-to-vehicle communication, and to request the second vehicle to surrender the first electricity supply equipment through vehicle-to-vehicle communication.

In the electricity supply system with such a configuration, the first vehicle and the second vehicle can directly exchange information without involving another device (a server or the like). Thus, the system can be easily simplified.

When a traveling route is set on the second vehicle, the second vehicle may be configured to select, as the second electricity supply equipment, electricity supply equipment on the traveling route among the plurality of pieces of electricity supply equipment.

In the electricity supply system with such a configuration, the second vehicle moves to the second electricity supply equipment on the traveling route after surrendering the first electricity supply equipment to the first vehicle. According to such a configuration, the second vehicle is restrained from being excessively behind a planned traveling schedule.

The second vehicle may be configured to refuse the request from the first vehicle when a predetermined refusal condition is met.

There is a possibility that the second vehicle's surrendering the electricity supply equipment to the first vehicle in response to the request from the first vehicle is not of benefit to the entire system, depending on a situation. The refusal condition may be set in order not to impair the benefit to the entire system.

Each of the first electricity supply equipment and the second electricity supply equipment may include a movable part including a plug configured to be connectable to an inlet of each vehicle, an actuator that moves the movable part, an electricity supply circuit that supplies electricity to the plug, and a control device that controls the actuator and the electricity supply circuit. The movable part may be configured to be displaced within a range of movement including a first position in which the plug is housed under a ground surface, and a second position in which the plug is exposed above the ground surface. The control device may be configured to cause electricity supply to be performed in a state where the movable part is in the second position and, when the electricity supply is finished, to displace the movable part into the first position.

Such electricity supply equipment can easily perform electricity supply to a driverless vehicle. Moreover, such electricity supply equipment is housed under the ground surface and is therefore less likely to obstruct traveling of vehicles.

Each of the first electricity supply equipment and the second electricity supply equipment may be installed in a road and may be configured to perform electricity supply to a vehicle parked on the road. Since electricity supply equipment with such a configuration is installed in a road, it is easy to secure a place of installation.

An electricity supply system according to a second aspect of the present disclosure includes a plurality of parking lots and a plurality of vehicles. Each of the plurality of parking lots includes at least one piece of electricity supply equipment. Among the plurality of vehicles, a target vehicle that intends to receive electricity supply at a first parking lot included in the plurality of parking lots selects one vehicle from among other vehicles being supplied with electricity in the first parking lot and requests the selected vehicle to surrender electricity supply equipment currently used by the selected vehicle when all electricity supply equipment included in the first parking lot is used by the other vehicles. The vehicle requested to surrender the electricity supply equipment surrenders the currently used electricity supply equipment to the target vehicle and moves, through automated driving, to a second parking lot selected from among the plurality of parking lots when the requested vehicle is able to travel as far as the second parking lot.

According to such a configuration, the target vehicle is restrained from being excessively behind a planned traveling schedule.

Each of the plurality of vehicles may include an electricity storage device that is chargeable with electricity externally supplied, and may be configured to travel by using the electricity stored in the electricity storage device. The target vehicle may be configured to preferentially select a vehicle with the electricity storage device having higher SOC when selecting a vehicle to be requested to surrender the currently used electricity supply equipment from among the other vehicles being supplied with electricity in the first parking lot.

According to such a configuration, traveling of a vehicle with the lower-SOC electricity storage device is restrained, so that vehicles running out of electricity are less likely to exist.

Each of the plurality of vehicles may be ranked. The target vehicle may be configured to preferentially select a vehicle with a lower rank when selecting a vehicle to be requested to surrender the currently used electricity supply equipment from among the other vehicles being supplied with electricity in the first parking lot.

Vehicles may be prioritized as described above. For example, by setting a higher rank on an emergency vehicle, the emergency vehicle can easily travel as scheduled.

An electricity supply method according to a third aspect of the present disclosure includes a requesting step, a determining step, and a moving step, which are described below.

In the requesting step, a first vehicle requests a second vehicle being supplied with electricity from first electricity supply equipment to surrender the first electricity supply equipment. In the determining step, when the second vehicle is requested by the first vehicle to surrender the first electricity supply equipment, the second vehicle determines whether or not the second vehicle is able to travel from the first electricity supply equipment to second electricity supply equipment. In the moving step, when it is determined, in the determining step, that the second vehicle is able to travel, the second vehicle moves from the first electricity supply equipment to the second electricity supply equipment through automated driving.

According to such an electricity supply method, a wait time of the first vehicle is also shortened, and the first vehicle is also restrained from being excessively behind a planned traveling schedule, as in the electricity supply system described above.

According to the present disclosure, the electricity supply system and the electricity supply method can be provided that can restrain a vehicle from being excessively behind a planned traveling schedule.

### BRIEF DESCRIPTION OF THE DRAWINGS

Features, advantages, and technical and industrial significance of exemplary embodiments of the present disclosure will be described below with reference to the accompanying drawings, in which like signs denote like elements, and wherein:

FIG. 1 is a diagram for describing a configuration of each of a vehicle and electricity supply equipment included in an electricity supply system according to a first embodiment of the present disclosure;

FIG. 2 shows a state in which a movable part of the electricity supply equipment shown in FIG. 1 has been raised;

FIG. 3 is a plane view showing a first state of the electricity supply system according to the first embodiment of the present disclosure;

FIG. 4 is a flowchart showing processing related to electricity supply executed by a control device of the electricity supply equipment shown in FIG. 1;

FIG. 5 is a plane view showing a second state of the electricity supply system according to the first embodiment of the present disclosure;

FIG. 6 is a flowchart showing processing performed when a first vehicle approaches first electricity supply equipment that the first vehicle intends to use, in the electricity supply system according to the first embodiment of the present disclosure;

FIG. 7 is a flowchart showing processing performed by a second vehicle being supplied with electricity from the first electricity supply equipment, in the electricity supply system according to the first embodiment of the present disclosure;

FIG. 8 is a diagram for describing operation of each of the first vehicle and the second vehicle included in the electricity supply system according to the first embodiment of the present disclosure;

FIG. 9 shows a schematic configuration of an electricity supply system according to a second embodiment of the present disclosure;

FIG. 10 is a plane view showing a configuration of a parking lot included in the electricity supply system according to the second embodiment of the present disclosure;

FIG. 11 is a diagram for describing operation of a target vehicle that intends to receive electricity supply at the parking lot shown in FIG. 10;

FIG. 12 is a flowchart showing processing performed when the target vehicle arrives at the parking lot, in the electricity supply system according to the second embodiment of the present disclosure;

FIG. 13 is a flowchart showing processing performed by a vehicle being supplied with electricity from electricity supply equipment, in the electricity supply system according to the second embodiment of the present disclosure;

FIG. 14 is a diagram for describing operation of each vehicle included in the electricity supply system according to the second embodiment of the present disclosure;

FIG. 15 is a flowchart showing a modification of the processing shown in FIG. 12; and

FIG. 16 is a flowchart showing a modification of each of the processing shown in FIGS. 7 and 13.

### DETAILED DESCRIPTION OF EMBODIMENTS

Hereinafter, embodiments of the present disclosure are described in detail with reference to the drawings. In the drawings, the same or equivalent parts are denoted by the same signs, and a description thereof is not repeated.

### First Embodiment

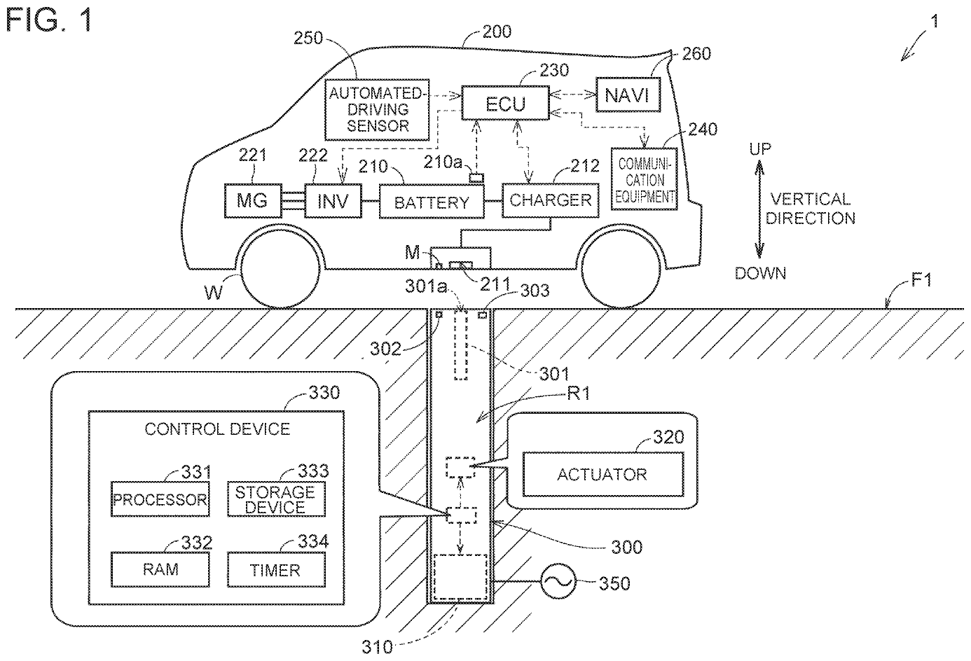

FIG. 1 is a diagram showing a schematic configuration of an electricity supply system according to the present embodiment. Referring to FIG. 1, the electricity supply system 1 includes an EVSE 300. EVSE refers to electric vehicle supply equipment. The EVSE 300 is configured to be able to be housed under a ground surface F1. The EVSE 300 corresponds to underground electricity supply equipment (electricity supply equipment that can be housed under the ground). A state of the EVSE 300 shown in FIG. 1 is a state in which the EVSE 300 is housed under the ground surface F1 (hereinafter, also referred to as “housed state”).

The EVSE 300 is installed in a recession R1 extending downward from the ground surface F1. In the housed state, the entire EVSE 300 is housed inside the recession R1. The EVSE 300 has, for example, a columnar casing. The casing of the EVSE 300 is fixed to a bottom face of the recession R1. Material of the casing may be metal, or may be plastic. A surface of the casing may be waterproofed.

The EVSE 300 includes an electricity supply circuit 310, an actuator 320, and a control device 330 within the casing. The EVSE 300 further includes a movable part 301 that can be displaced in a vertical direction (up-down direction). The movable part 301 is a member in a stick-like shape including a connector 301a at a distal end of the member. The connector 301a corresponds to a plug of the EVSE 300. The actuator 320 moves the movable part 301. In the housed state, the entire movable part 301 is housed within the casing of the EVSE 300, and a top face of the EVSE 300 is flush with the ground surface F1. A sealing member may be provided in a gap between a circumferential face of the casing of the EVSE 300 and an inner wall of the recession R1.

The connector 301a of the movable part 301 is connected to the electricity supply circuit 310 through an undepicted electric wire. The movable part 301 may include a communication line connected to the control device 330, in addition to the electric wire connected to the electricity supply circuit 310. The electricity supply circuit 310 is configured to be supplied with electricity from an alternating-current electricity supply 350 and to supply electricity to the movable part 301 (more specifically, the connector 301a). The electricity supply circuit 310 includes an electricity conversion circuit, and functions as an EVSE-side charger. The alternating-current electricity supply 350 supplies alternating-current electricity to the electricity supply circuit 310. The alternating-current electricity supply 350 may be a commercial electricity supply (for example, an electric power system provided by an electric power company). The electricity supply circuit 310 is controlled by the control device 330.

The actuator 320 is configured to move the movable part 301 in the vertical direction by directly or indirectly applying motive power to the movable part 301. The actuator 320 may be an electric actuator that generates motive power by using electricity supplied from the electricity supply circuit 310. A displacement mechanism of the movable part 301 may be of a rack-and-pinion type. For example, a configuration may be made such that a rack gear is fixed to the movable part 301, and the actuator 320 rotationally drives a pinion gear engaged with the rack gear. Alternatively, a configuration may be made such that a rod connected to a piston is fixed to the movable part 301, and the actuator 320 hydraulically moves the piston. Alternatively, the actuator 320 may generate magnetic force by using electricity and directly apply motive power to the movable part 301 by using the magnetic force. The actuator 320 is controlled by the control device 330.

The control device 330 may be a computer. The control device 330 includes a processor 331, a random access memory (RAM) 332, a storage device 333, and a timer 334. For the processor 331, for example, a central processing unit (CPU) can be adopted. The storage device 333 is configured to be able to retain stored information. The storage device 333 stores a program and information (for example, a map, a mathematical formula, and various parameters) used by the program. In the present embodiment, the processor 331 executes the program stored in the storage device 333, whereby various control of the EVSE 300 is performed. However, the various control of the EVSE 300 is performed not only by software, but can also be performed by dedicated hardware (an electronic circuit). Note that any number of processors may be included in the control device 330, and a processor may be prepared for each predetermined control.

A connection style of the EVSE 300 is underfloor connection. The underfloor connection is a style in which, in a state where a vehicle is parked over the movable part 301 housed under the ground surface F1, the connector 301a of the movable part 301 is raised toward the vehicle from under a floor of the vehicle and is connected to an inlet provided on a lower portion of the vehicle. The connector 301a of the movable part 301 is configured to be able to connect to an inlet provided on a lower portion of a vehicle parked at a predetermined electricity supply position. The electricity supply position of the EVSE 300 according to the present embodiment is a position where the connector 301a and the inlet of the vehicle coincide from a planar view (that is, a position where respective X, Y coordinates of the connector 301a and the inlet coincide). The movable part 301 is configured to be displaced within a range of movement including a first position in which the connector 301a is housed under the ground surface F1 and a second position in which the connector 301a is connected to an inlet of a vehicle above the ground surface F1. In the present embodiment, a vehicle 200 is configured to be able to use the EVSE 300. An inlet 211 is provided on a lower portion of the vehicle 200.

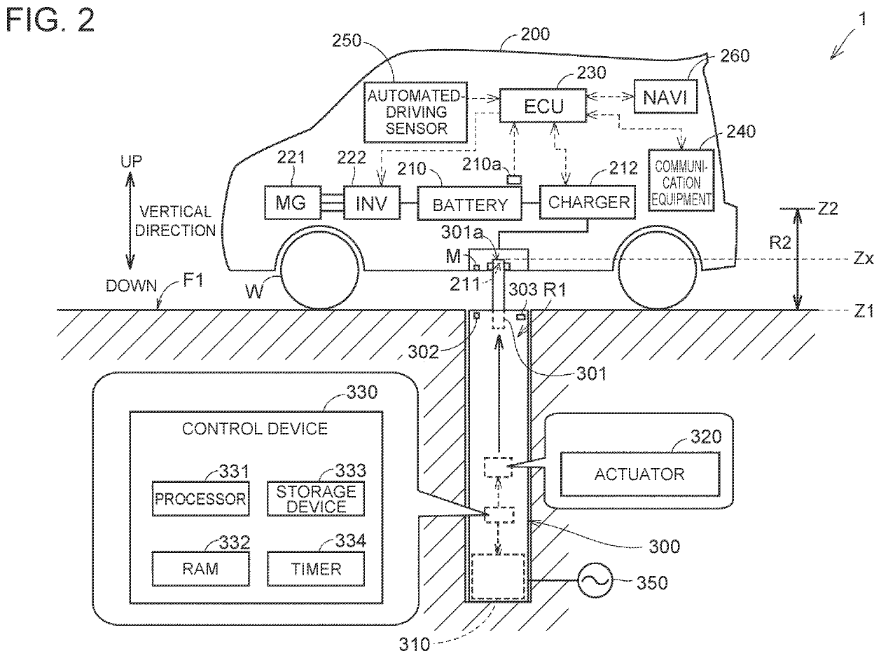

FIG. 2 shows a state in which the movable part 301 has been raised. Referring to FIG. 2, the movable part 301 is displaced in the vertical direction (is raised and lowered) such that a position of the connector 301a is changed. The state of the EVSE 300 shown in FIG. 2 is a state in which the connector 301a has been raised to a position at which the connector 301a is connected to the inlet 211 of the vehicle 200 (for example, a position Zx shown in FIG. 2) (hereinafter, also referred to as “raised state”). Hereinafter, for descriptive convenience, a position of the connector 301a of the movable part 301 is regarded as a position of the movable part 301.

The movable part 301 is configured to be displaced within a range of movement R2. A lower-limit position Z1 of the range of movement R2 is at the same level as the ground surface F1. When the position of the movable part 301 is the lower-limit position Z1, the entire movable part 301 (including the connector 301a) is housed under the ground surface F1 (see FIG. 1). When the position of the movable part 301 is higher than the lower-limit position Z1, the connector 301a is exposed above the ground surface F1. An upper-limit position Z2 of the range of movement R2 is set at a position that is sufficiently high in relation to heights of inlets of vehicles. The range of movement R2 includes a first position in which the connector 301a is housed under the ground surface F1 (for example, the lower-limit position Z1), and a second position in which the connector 301a is connected to an inlet of a vehicle above the ground surface F1 (for example, the position Zx shown in FIG. 2). Although the lower-limit position Z1 is at the same level as the ground surface F1 in the present embodiment, the lower-limit position Z1 may be set to a lower position than the ground surface F1.

The EVSE 300 further includes a parking sensor 302 and a communication device 303. The parking sensor 302 is a sensor that acquires misalignment information indicating a relative positional relationship between an inlet of a vehicle and the connector 301a (for example, a direction and a distance of misalignment). The parking sensor 302 may acquire the misalignment information related to the vehicle 200, for example, by recognizing a mark M provided near the inlet 211 of the vehicle 200. The parking sensor 302 may include at least one of a laser and a camera. A result of detection by the parking sensor 302 is output to the control device 330. The control device 330 can determine, by using the result of detection by the parking sensor 302, whether or not a vehicle is parked at the predetermined electricity supply position. For example, when a stationary state of the vehicle 200 continues until a predetermined time period passes after the parking sensor 302 detects that the vehicle 200 stops at the electricity supply position, the control device 330 may determine that the vehicle 200 is parked at the electricity supply position.

The communication device 303 includes various communication interfaces (I/Fs). The communication device 303 includes a communication I/F for communicating with the vehicle 200. The communication device 303 transmits information received from the outside of the EVSE 300 to the control device 330. The control device 330 is configured to communicate with the outside of the EVSE 300 via the communication device 303.

The vehicle 200 shown in FIGS. 1 and 2 is an electrified vehicle including a battery 210, equipment for traveling by using electricity stored in the battery 210 (for example, a motor generator 221 and an inverter 222, which will be described later), and equipment for charging the battery 210 with electricity externally supplied (for example, the inlet 211 and a charger 212, which will be described later). The vehicle 200 according to the present embodiment is a battery electric vehicle (EV) without including an engine (internal combustion engine).

The vehicle 200 further includes an electronic control unit (hereinafter, referred to as “ECU”) 230 and communication equipment 240. The ECU 230 may be a computer. The ECU 230 includes a processor, a RAM, and a storage device (all not shown). The processor executes a program stored in the storage device, whereby various vehicle control is performed. However, the vehicle control is performed not only by software, but can also be performed by dedicated hardware (an electronic circuit).

The ECU 230 is configured to communicate with the outside of the vehicle 200 via the communication equipment 240. The communication equipment 240 includes various communication interfaces (I/Fs). The communication equipment 240 includes a communication I/F for performing vehicle-to-vehicle communication, which will be described later. Moreover, the communication equipment 240 mounted on the vehicle 200 and the communication device 303 mounted on the EVSE 300 are configured to be able to communicate with each other. Further, the communication equipment 240 may be configured to perform wireless communication with a predetermined user terminal (for example, a mobile terminal such as a smart phone, a tablet terminal, or a wearable device). The communication equipment 240 may be configured to perform wired communication with a predetermined service tool.

The battery 210 includes a secondary battery such as lithium ion battery or nickel-metal hydride battery. The secondary battery may be a battery pack or an all-solid-state battery. Note that another electricity storage device such as electric double-layer capacitor may be adopted instead of the secondary battery.

The vehicle 200 further includes a monitoring module 210a that monitors a state of the battery 210. The monitoring module 210a includes various sensors that detect the state of the battery 210 (for example, voltage, current, and temperature), and outputs a result of detection to the ECU 230. The monitoring module 210a may be a battery management system (BMS) that, in addition to the sensor function, further includes a state-of-charge (SOC) estimation function, a state-of-health (SOH) estimation function, a cell voltage equalization function, a diagnosis function, and a communication function. The ECU 230 can acquire a state (for example, temperature, current, voltage, SOC, and internal resistance) of the battery 210, based on an output of the monitoring module 210a.

The vehicle 200 includes the motor generator (hereinafter, referred to as “MG”) 221 and the inverter (hereinafter, referred to as “INV”) 222 for electrified traveling. The MG 221 is, for example, a three-phase alternating-current motor generator. The MG 221 is configured to be driven by the INV 222 and to cause driving wheels W of the vehicle 200 to rotate. The INV 222 is controlled by the ECU 230. The INV 222 drives the MG 221 by using electricity supplied from the battery 210. Moreover, the MG 221 generates regenerative electricity and supplies the generated electricity to the battery 210 via the INV 222. Note that a drive system of the vehicle 200 is not limited to front-wheel drive, but may be rear-wheel drive or four-wheel drive.

The vehicle 200 is an automated driving vehicle configured to be capable of automated driving. The vehicle 200 further includes an automated-driving sensor 250 and a navigation system (hereinafter, also referred to as “NAVI”) 260.

The automated-driving sensor 250 is a sensor used for automated driving. However, the automated-driving sensor 250 may be used for predetermined control when automated driving is not performed. The automated-driving sensor 250 includes a sensor that acquires information for recognizing an external environment around the vehicle 200, and a sensor that acquires information related to a position and an attitude of the vehicle 200. The automated-driving sensor 250 may include, for example, at least one of a camera, a millimeter-wave radar, and a lidar. The automated-driving sensor 250 may include, for example, at least one of an inertial measurement unit (IMU) and a global positioning system (GPS) sensor.

The NAVI 260 includes a global positioning system (GPS) module and a storage device (all not shown). The storage device stores map information. The GPS module is configured to receive a signal from an undepicted GPS satellite (hereinafter, referred to as “GPS signal”). The NAVI 260 can identify a position of the vehicle 200 by using the GPS signal. The NAVI 260 is configured to perform path search to find an optimal route (for example, the shortest route) from a current position of the vehicle 200 to a destination by referring to the map information. The NAVI 260 may sequentially update the map information by performing wireless communication with a data center.

The vehicle 200 is configured to be capable of driverless autonomous traveling according to a predetermined traveling schedule. The vehicle 200 does not need to include a steering wheel. The traveling schedule includes, for example, a time of arrival at the destination. An arbitrary method may be used for setting the traveling schedule. For example, a user may operate a user terminal (for example, a mobile terminal) that can perform wireless communication with the vehicle 200, whereby a traveling schedule and a destination may be set on the ECU 230. Alternatively, the user may operate a service tool that is connected to the vehicle 200 such as to be able to perform wired communication with the vehicle 200, or an in-vehicle human machine interface (HMI), whereby a traveling schedule and a destination may be set on the ECU 230. The vehicle 200 functions as, for example, an automatic guided vehicle (AGV). The user may cause the AGV to perform transport from a vendor campus to another vendor campus, or may cause the AGV to perform delivery to a private home.

Note that the vehicle 200 is not limited to the AGV, but may be a mobile shop vehicle or may be a robotaxi. When the vehicle 200 is in the form of mobile shop vehicle, an operating company of the shop may set a traveling schedule and a destination based on a request of a user (for example, a small organization such as a local government). When the vehicle 200 is in the form of robotaxi, a passenger may input a destination (and also a way-stop point if necessary), the ECU 230 then may present a traveling route and a traveling schedule suitable to the input content to the passenger, and the traveling route and the traveling schedule may be determined by acceptance with the passenger.

When the traveling schedule and the destination are set on the ECU 230, the ECU 230 instructs the NAVI 260 to perform path search, and a traveling route from the current position of the vehicle 200 to the destination is determined. The NAVI 260 performs the path search while taking the SOC of the battery 210 into consideration. When the vehicle 200 cannot continue to cruise from the current position to the destination (that is, when the destination is so far, considering remaining charge of the battery 210, that the vehicle 200 cannot travel as far as the destination), a traveling route including one or more EVSEs as way-stop points is determined. The vehicle 200 can extend a distance to empty of the vehicle 200 by receiving electricity supply at an EVSE on the traveling route. When the traveling route includes a way-stop point, the traveling schedule may further include a time of arrival at the way-stop point.

The ECU 230 is configured to execute automated driving (including automated parking) in accordance with a predetermined automated driving program. The ECU 230 executes the automated driving of the vehicle 200 following the traveling route and the traveling schedule by controlling an acceleration device, a braking device, and a steering system (all not shown) of the vehicle 200 by using various information acquired by the automated-driving sensor 250. The automated driving program may be sequentially updated over the air (OTA).

The vehicle 200 includes the inlet 211 and the charger 212 for contact charge. The inlet 211 is provided in the lower portion of the vehicle 200 (for example, near a floor panel). The mark M for position detection is provided near the inlet 211. Moreover, the vehicle 200 includes a circuit that detects a connection state of the inlet 211 (for example, a circuit that detects whether or not the connector 301a is connected to the inlet 211), which is not depicted.

The inlet 211 is configured such that that the connector 301a of the EVSE 300 can connect to the inlet 211. Each of the inlet 211 and the connector 301a includes a built-in contact point, and when the connector 301a is connected to the inlet 211, the contact points come into contact, and the inlet 211 and the connector 301a are electrically connected. Hereinafter, a state in which the connector 301a is connected to the inlet 211 (that is, a state in which the EVSE 300 and the vehicle 200 are electrically connected) is referred to as “plug-in state”. A state in which the connector 301a is not connected to the inlet 211 (that is, a state in which the EVSE 300 and the vehicle 200 are not electrically connected) is referred to as “plug-out state”.

The charger 212 includes an electricity conversion circuit (not shown). The electricity conversion circuit converts electricity externally supplied to the inlet 211 into electricity suitable to charge the battery 210. For example, when alternating-current electricity is supplied from the inlet 211, the charger 212 converts the supplied alternating-current electricity into direct-current electricity and then supplies the direct-current electricity to the battery 210. The charger 212 is controlled by the ECU 230.

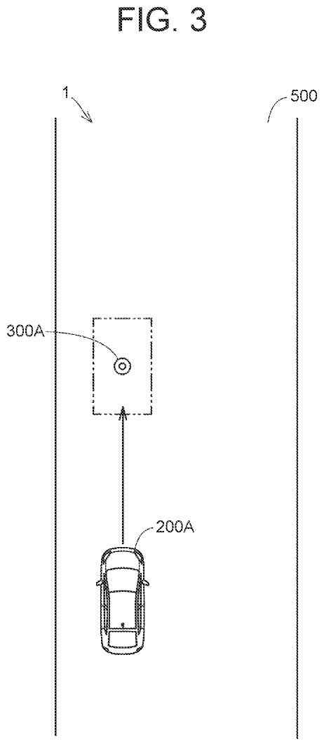

The electricity supply system 1 according to the present embodiment includes a plurality of pieces of electricity supply equipment (including EVSEs 300A and 300B, which will be described later) and a plurality of vehicles (including vehicles 200A and 200B, which will be described later). Although each piece of the electricity supply equipment included in the electricity supply system 1 may have mutually different configurations, the electricity supply equipment has the same configuration as the EVSE 300 shown in FIGS. 1 and 2 in the present embodiment. Moreover, although each vehicle included in the electricity supply system 1 may also have mutually different configurations, the vehicles have the same configuration as the vehicle 200 shown in FIGS. 1 and 2 in the present embodiment. Hereinafter, operation of the electricity supply system 1 is described by using FIGS. 3 to 8.

FIG. 3 is a plane view showing a first state of the electricity supply system 1. Referring to FIG. 3, the electricity supply system 1 includes a road 500, the EVSE 300A, and the vehicle 200A. The EVSE 300A is provided in the road 500 and is configured to supply electricity to a vehicle parked on the road 500. When unused, the EVSE 300A is in the housed state (for example, the state shown in FIG. 1) such as not to obstruct traveling of vehicles on the road 500. A traveling route and a traveling schedule are set on the vehicle 200A as described above. The vehicle 200A performs driverless autonomous traveling on the road 500 toward a destination, according to the set traveling route and traveling schedule. In the example shown in FIG. 3, the EVSE 300A is set as a way-stop point along the traveling route for the vehicle 200A. Accordingly, the vehicle 200A is parked at the electricity supply position of the EVSE 300A in order to receive electricity supply from the EVSE 300A. When the vehicle 200A is parked at the electricity supply position of the EVSE 300A, the EVSE 300A supplies electricity to the vehicle 200A.

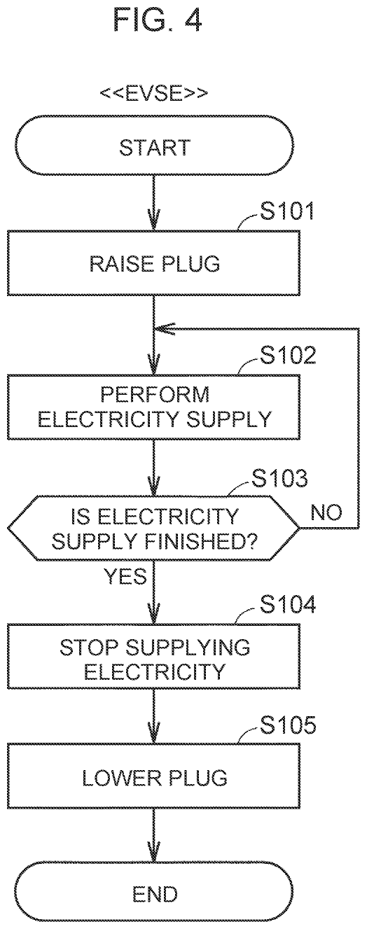

FIG. 4 is a flowchart showing processing related to electricity supply executed by the control device 330 (FIG. 1) of an EVSE included in the electricity supply system 1. For example, the processing shown in the flowchart is started when the control device 330 of the EVSE 300A determines that the vehicle 200A is parked at the electricity supply position of the EVSE 300A. Accordingly, at a timing when the processing shown in FIG. 4 is started, a state is such that the vehicle 200A is parked over the movable part 301 housed under the ground surface F1 (see FIG. 1). Hereinafter, each step in the flowchart is simply represented by “S”. In the following, FIGS. 1 and 2 are referred to, with EVSE 300, vehicle 200 replaced with EVSE 300A, vehicle 200A shown in FIG. 3, respectively.

Referring to FIG. 4 as well as FIG. 1, in S101, the movable part 301 of the EVSE 300A is raised. More specifically, the control device 330 controls the actuator 320 such that the movable part 301 is displaced from the first position to the second position. Thus, the connector 301a (plug) of the movable part 301 is raised under the floor of the vehicle 200A toward the inlet 211 of the vehicle 200A and is connected to the inlet 211 provided in the lower portion of the vehicle 200A.

Referring to FIG. 2, through the process in S101, the EVSE 300A falls in the raised state (for example, the state shown in FIG. 2). Moreover, the vehicle 200A and the EVSE 300A fall in the plug-in state. In the plug-in state, communication between the vehicle 200A and the EVSE 300A is enabled, and transfer of electricity between the vehicle 200A and the EVSE 300A is also enabled. The ECU 230 of the vehicle 200A communicates with the control device 330 of the EVSE 300A via the movable part 301. However, the manner of communication is not limited to such a manner, and the ECU 230 and the control device 330 may perform wireless communication in each of the plug-in state and the plug-out state.

Referring to FIG. 4 as well as FIG. 2, subsequently in S102, the control device 330 controls the electricity supply circuit 310 such that electricity is supplied from the EVSE 300A to the vehicle 200A. Through the process in S102, electricity supply to the vehicle 200A is started. More specifically, at the EVSE 300A, the electricity supply circuit 310 transforms alternating-current electricity supplied from the alternating-current electricity supply 350 into alternating-current electricity suitable for electricity supply to the vehicle 200A (for example, transforms voltage), and supplies the transformed electricity to the connector 301a. In the plug-in state, electricity supplied from the electricity supply circuit 310 to the connector 301a is input to the inlet 211 of the vehicle 200A. Then, the battery 210 is charged in the vehicle 200A. More specifically, the electricity input into the inlet 211 is supplied to the battery 210 via the charger 212. While the battery 210 is being charged, the control device 330 controls the electricity supply circuit 310 such as to adjust supplied electricity, and the ECU 230 controls the charger 212 such as to adjust received electricity.

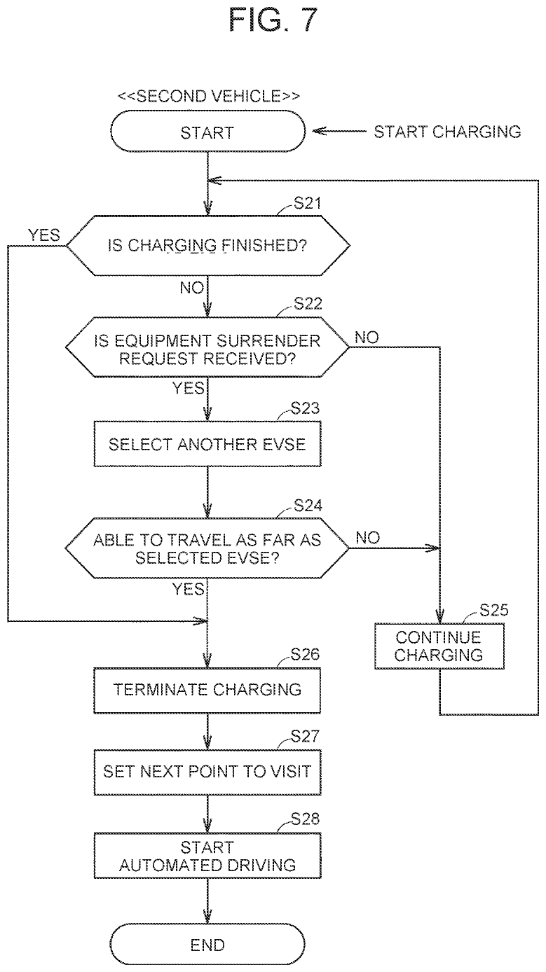

Subsequently in S103, the control device 330 determines whether or not electricity supply to the vehicle 200A is finished. In the present embodiment, it is determined whether or not electricity supply to the vehicle 200A is finished, based on whether or not the control device 330 receives an instruction to stop supplying electricity. For example, the instruction to stop supplying electricity is transmitted from the vehicle 200A to the EVSE 300A (see S26 in FIG. 7, which will be described later). The control device 330 causes electricity supply to the vehicle 200A to continue until the instruction to stop supplying electricity is received (S102).

At the EVSE 300A, when the instruction to stop supplying electricity is received (YES in S103), in S104, the control device 330 controls the electricity supply circuit 310 such as to stop supplying electricity in accordance with the instruction. Thereafter, in S105, the movable part 301 of the EVSE 300A is lowered. More specifically, the control device 330 controls the actuator 320 such that the movable part 301 is displaced from the second position to the first position. The control device 330 lowers the movable part 301 to the lower-limit position Z1 (FIG. 2) of the range of movement R2. Through the process in S105, the movable part 301 of the EVSE 300A is lowered, and the connector 301a of the movable part 301 separates from the inlet 211 of the vehicle 200A, so that the vehicle 200A and the EVSE 300A fall in the plug-out state. Moreover, when the movable part 301 comes to the lower-limit position Z1, the connector 301a of the movable part 301 becomes flush with the ground surface F1. Thus, the EVSE 300A falls into the housed state (see FIG. 1) again.

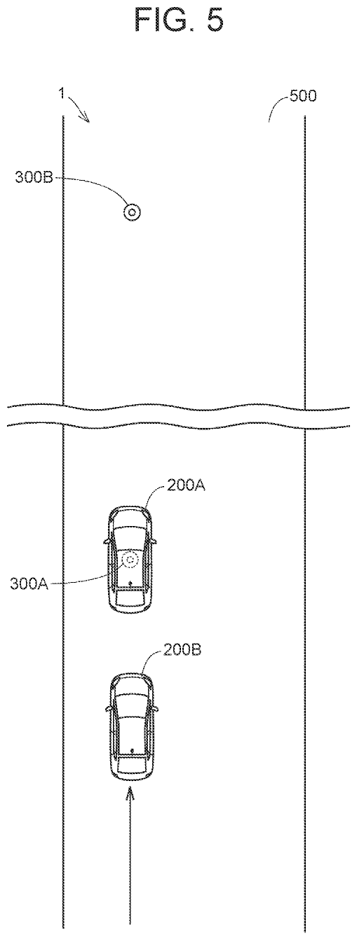

FIG. 5 is a plane view showing a second state (a state after the first state shown in FIG. 3) of the electricity supply system 1. Referring to FIG. 5, the electricity supply system 1 further includes the EVSE 300B and the vehicle 200B. The vehicle 200B performs driverless autonomous traveling on the road 500 toward a destination, according to a set traveling route and a set traveling schedule. The EVSE 300B is provided in the road 500.

In the second state shown in FIG. 5, the EVSE 300B is not used and is in the housed state (for example, the state shown in FIG. 1). On the other hand, the vehicle 200A is being supplied with electricity from the EVSE 300A. In other words, in the processing shown in FIG. 4, NO is determined in S103, and the process in S102 is repeatedly performed. In the example shown in FIG. 5, the EVSE 300A is set as a way-stop point along the traveling route for the vehicle 200B. Since the EVSE 300A is being used by the vehicle 200A, the vehicle 200B requests the vehicle 200A to surrender the EVSE 300A. More specifically, the vehicle 200B comes within a predetermined range around the EVSE 300A (vehicle 200A) and makes the request through vehicle-to-vehicle communication. However, when the SOC of the vehicle 200A (that is, the SOC of the battery 210 mounted on the vehicle 200A) is low, the vehicle 200B makes the request after waiting until the SOC of the vehicle 200A becomes high through electricity supply from the EVSE 300A to the vehicle 200A. In the example shown in FIG. 5, the vehicle 200B corresponds to “first vehicle”, and the vehicle 200A corresponds to “second vehicle”. Moreover, the EVSE 300A corresponds to “first electricity supply equipment”, and the EVSE 300B corresponds to “second electricity supply equipment”.

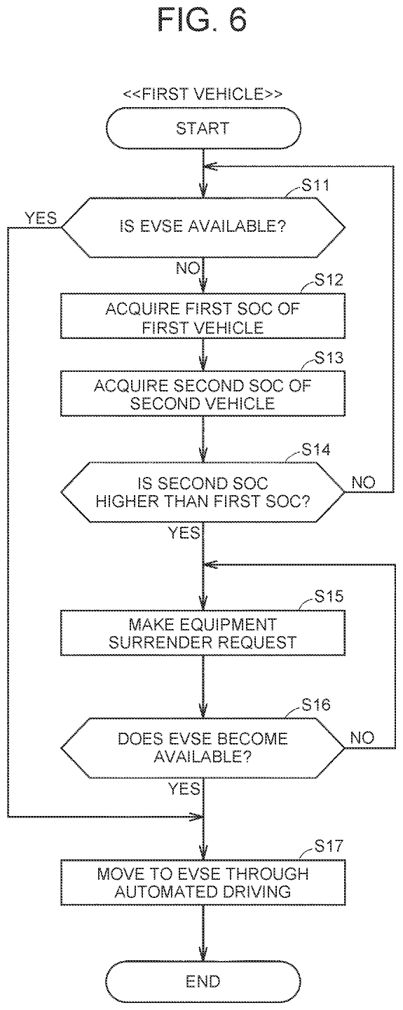

FIG. 6 is a flowchart showing processing performed when the first vehicle approaches the first electricity supply equipment that the first vehicle intends to use. The processing shown in the flowchart is performed by the control device of the first vehicle (hereinafter, also referred to as “first control device”). In the example shown in FIG. 5, the ECU 230 of the vehicle 200B corresponds to the first control device. When the vehicle 200B intends to use the EVSE 300A, for example, the vehicle 200B comes within the predetermined range around the EVSE 300A as shown in FIG. 5, is parked, and then performs the processing shown in FIG. 6, which is described below.

Referring to FIG. 6 as well as FIGS. 2 and 5, in S11, the first control device determines whether or not the first electricity supply equipment is available. In the example shown in FIG. 5, the EVSE 300A corresponds to the first electricity supply equipment. NO is determined in S11 when the EVSE 300A is being used by a vehicle (for example, the vehicle 200A) other than the vehicle 200B. The first control device determines whether or not the EVSE 300A is being used, for example, based on an output of the automated-driving sensor 250 of the vehicle 200B. Alternatively, the first control device may recognize that the EVSE 300A is being used, based on a signal transmitted to the vehicle 200B from the vehicle 200A that is using the EVSE 300A.

When the first electricity supply equipment is not available (NO in S11), the first control device sequentially executes processes in S12 to S14, which are described below.

In S12, the first control device acquires the SOC of the first vehicle (hereinafter, also referred to as “first SOC”). In the example shown in FIG. 5, the SOC of the battery 210 mounted on the vehicle 200B corresponds to the first SOC. The first control device acquires the first SOC, for example, based on an output of the monitoring module 210a of the vehicle 200B.

In S13, the first control device acquires the SOC of the second vehicle (hereinafter, also referred to as “second SOC”). In the example shown in FIG. 5, the SOC of the battery 210 mounted on the vehicle 200A corresponds to the second SOC. The first control device acquires the second SOC from the vehicle 200A, for example, through vehicle-to-vehicle communication between the vehicle 200A and the vehicle 200B.

In S14, the first control device determines whether or not the second SOC is higher than the first SOC. When the second SOC is not higher than the first SOC (NO in S14), the processing returns to S11. During a period for which NO is determined in S14, the first control device repeatedly executes the processing in S11 to S14, and, on the other hand, the second SOC increases as a result of the vehicle 200A (second vehicle) being supplied with electricity from the EVSE 300A (first electricity supply equipment).

When the second SOC is higher than the first SOC (YES in S14), in S15, the first control device requests the second vehicle to surrender the first electricity supply equipment. In the example shown in FIG. 5, the first control device requests the vehicle 200A to surrender the EVSE 300A, through vehicle-to-vehicle communication between the vehicle 200A and the vehicle 200B. Hereinafter, requesting a vehicle using some electricity supply equipment to surrender the electricity supply equipment is also referred to as “equipment surrender request”.

In S16, the first control device determines whether or not the first electricity supply equipment becomes available. In the example shown in FIG. 5, NO is determined in S16 while the vehicle 200A (second vehicle) is using the EVSE 300A (first electricity supply equipment), and the processing returns to S15. The first control device repeats the process in S15 and continues to make an equipment surrender request to the vehicle 200A. When the vehicle 200A stops using the EVSE 300A in response to the equipment surrender request and leaves the EVSE 300A, the EVSE 300A falls in an available state (that is, a state in which a vehicle other than the vehicle 200A can use the EVSE 300A). When the EVSE 300A becomes available (YES in S16), the processing advances to S17. The processing also advances to S17 when YES is determined in S11. For example, when the vehicle 200A leaves the EVSE 300A (YES in S11) during the period for which the second SOC is not higher than the first SOC (NO in S14), the processing advances to S17.

In S17, the first vehicle moves to the first electricity supply equipment through automated driving. In the example shown in FIG. 5, after the vehicle 200A (second vehicle) leaves the EVSE 300A (first electricity supply equipment), the vehicle 200B (first vehicle) moves to the EVSE 300A through automated driving. When the vehicle 200B is parked at the electricity supply position of the EVSE 300A, the EVSE 300A performs electricity supply to the vehicle 200B through the processing shown in FIG. 4. Through the electricity supply, the vehicle 200B can store electricity for traveling according to the set traveling route in the battery 210.

FIG. 7 is a flowchart showing processing performed by a vehicle (second vehicle) that is being supplied with electricity from electricity supply equipment. The processing shown in the flowchart is executed by the control device of the second vehicle (hereinafter, also referred to as “second control device”). In the example shown in FIG. 5, the ECU 230 of the vehicle 200A corresponds to the second control device. For example, when the vehicle 200A starts using the EVSE 300A, the processing shown in FIG. 7 is started.

Referring to FIG. 7 as well as FIGS. 2 and 5, in S21, the second control device determines whether or not charging by the currently used electricity supply equipment is finished. In the example shown in FIG. 5, the vehicle 200A is using the EVSE 300A, and the battery 210 of the vehicle 200A is charged with electricity supplied from the EVSE 300A. It is determined in S21 whether or not such charging is finished. The second control device may determine that charging of the battery 210 is finished (YES in S21) when the SOC of the battery 210 becomes a predetermined value (for example, a value indicating full charge) or higher.

When charging is not finished (NO in S21), in S22, the second control device determines whether or not an equipment surrender request (S15 in FIG. 6) is received. In the example shown in FIG. 5, when an equipment surrender request is transmitted from the vehicle 200B to the vehicle 200A, that is, when the vehicle 200A is requested by the vehicle 200B to surrender the EVSE 300A (YES in S22), the processing advances to S23.

In S23, the second control device selects one piece of electricity supply equipment (second electricity supply equipment) among the plurality of pieces of electricity supply equipment included in the electricity supply system 1. The second electricity supply equipment is electricity supply equipment other than the electricity supply equipment currently used by the second vehicle, and is set as a next point for the second vehicle to visit through a process (S27), which will be described later. For example, the second control device selects, as the second electricity supply equipment, electricity supply equipment that is located on a closer side to the destination than the EVSE 300A (the electricity supply equipment currently used by the second vehicle) on the traveling route set on the vehicle 200A (second vehicle), and is the closest to the EVSE 300A, among the plurality of pieces of electricity supply equipment included in the electricity supply system 1. In the example shown in FIG. 5, the EVSE 300B corresponds to the second electricity supply equipment. However, the method is not limited to this, and an arbitrary method may be used for selecting an EVSE in S23. The second control device may select the second electricity supply equipment by using traffic information (for example, congestion information).

In S24, the second control device determines whether or not the second vehicle can travel as far as the second electricity supply equipment selected in S23. For example, YES is determined in S24 when a distance from the current position of the second vehicle to the second electricity supply equipment is equal to or shorter than a distance to empty of the second vehicle. In the example shown in FIG. 5, the distance to empty of the vehicle 200A corresponds to the second SOC (that is, remaining charge of the battery 210 of the vehicle 200A). The second control device determines, based on the second SOC, whether or not the vehicle 200A can travel as far as the second electricity supply equipment.

When it is determined that the second vehicle cannot travel as far as the second electricity supply equipment (that is, electricity in the battery 210 is insufficient) (NO in S24), the second control device continues charging the battery 210 (S25), and the processing returns to S21. The processing also advances to S25 when the vehicle 200A does not receive an equipment surrender request (NO in S22), and charging of the battery 210 is continued. Charging of the battery 210 of the vehicle 200A is performed, for example, in the state shown in FIG. 2 (see S102 in FIG. 4).

The second SOC increases as a result of changing being continued in S25. Due to the increased second SOC, YES is more easily determined in S21 or S24. When YES is determined in S21 or S24, the processing advances to S26.

In S26, the second control device terminates the charging. In the example shown in FIG. 5, the second control device (the ECU 230 of the vehicle 200A) transmits, to the EVSE 300A, an instruction to stop supplying electricity. Thus, the EVSE 300A stops supplying electricity to the vehicle 200A (S104 in FIG. 4), and the movable part 301 of the EVSE 300A is lowered (S105 in FIG. 4).

In S27, the second control device sets a next point for the second vehicle to visit. When YES is determined in S21, in S27, the second control device sets the next point for the second vehicle to visit, according to the traveling route. The next point to visit is, for example, an EVSE or the destination. When YES is determined in S24, in S27, the second control device sets the second electricity supply equipment selected in S23 as the next point for the second vehicle to visit (that is, a way-stop point on the traveling route).

Thereafter, in S28, the second control device causes the second vehicle to depart through automated driving toward the next point to visit. In the example shown in FIG. 5, the vehicle 200A departs from the EVSE 300A, whereby the EVSE 300A falls in the available state. Thus, YES is determined in S11 or S16 in FIG. 6.

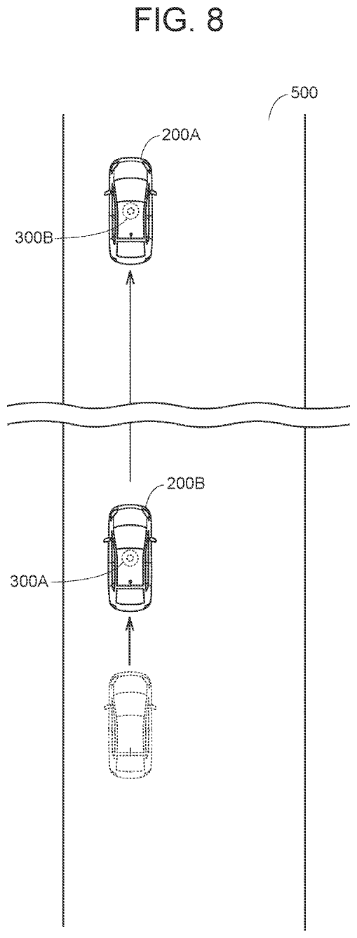

FIG. 8 is a diagram for describing operation of each of the first vehicle and the second vehicle included in the electricity supply system 1. Each of the first vehicle and the second vehicle included in the electricity supply system 1 is an automated driving vehicle configured to be capable of driverless traveling according to a predetermined traveling schedule. Hereinafter, operation of the second vehicle when the second vehicle receives an equipment surrender request from the first vehicle is described by using FIGS. 5, 7, and 8.

For example, when the vehicle 200A (second vehicle) that is being supplied with electricity from the EVSE 300A (first electricity supply equipment) is requested by the vehicle 200B (first vehicle) to surrender the EVSE 300A as shown in FIG. 5, YES is determined in S22 in FIG. 7. In S23 in FIG. 7, the EVSE 300B (second electricity supply equipment) is selected from among the plurality of EVSEs included in the electricity supply system 1, and in S24 in FIG. 7, it is determined whether or not the vehicle 200A can travel as far as the EVSE 300B. When the vehicle 200A can travel as far as the EVSE 300B (YES in S24 in FIG. 7), S26 to S28 in FIG. 7 are performed. Thus, the vehicle 200A surrenders the EVSE 300A to the vehicle 200B and moves to the EVSE 300B through automated driving as shown in FIG. 8. Thereafter, the vehicle 200B is parked at the electricity supply position of the EVSE 300A and receives electricity supply from the EVSE 300A. The vehicle 200B starts using the EVSE 300A and performs the processing shown in FIG. 7.

As described above, an electricity supply method according to the present embodiment includes S15 (requesting step) in FIG. 6, S24 (determining step) in FIG. 7, and S28 (moving step) in FIG. 7. In S15 in FIG. 6, the first vehicle requests the second vehicle being supplied with electricity from the first electricity supply equipment to surrender the first electricity supply equipment. When the second vehicle is requested by the first vehicle to surrender the first electricity supply equipment (YES in S22 in FIG. 7), in S24 in FIG. 7, the second vehicle determines whether or not the second vehicle can travel from the first electricity supply equipment to the second electricity supply equipment. When it is determined in S24 in FIG. 7 that the second vehicle can travel, in S28 in FIG. 7, the second vehicle moves from the first electricity supply equipment to the second electricity supply equipment through automated driving. According to such an electricity supply method, when the second vehicle is requested by the first vehicle to surrender the first electricity supply equipment, the second vehicle surrenders the first electricity supply equipment to the first vehicle and moves to the second electricity supply equipment if the second vehicle can travel as far as the second electricity supply equipment. Thus, a wait time of the first vehicle is shortened, and the first vehicle is restrained from being excessively behind the planned traveling schedule. Moreover, the second vehicle can receive electricity supply from the second electricity supply equipment instead of the first electricity supply equipment.

Note that each piece of electricity supply equipment included in the electricity supply system 1 may be configured to perform the processing shown in FIG. 4. Moreover, each vehicle included in the electricity supply system 1 may be configured to perform the processing shown in each of FIGS. 6 and 7.

In the processing shown in FIG. 6, when a predetermined condition is satisfied (more specifically, YES is determined in S14), the first vehicle requests the second vehicle to surrender the first electricity supply equipment. The processing is not limited to this, and S12 to S14 can be omitted in the processing shown in FIG. 6. In S14, distances to empty may be compared, instead of SOCs.

### Second Embodiment

An electricity supply system according to a second embodiment of the present disclosure is described. Since the second embodiment shares many common parts with the first embodiment, differences are mainly described, and a description of the common parts is omitted.

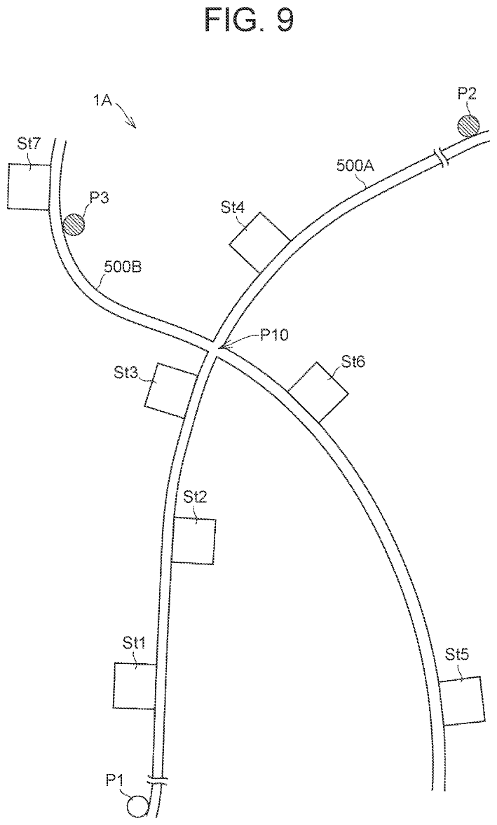

FIG. 9 shows a schematic configuration of the electricity supply system according to the second embodiment of the present disclosure. Referring to FIG. 9, the electricity supply system 1A according to the second embodiment includes a plurality of roads, a plurality of parking lots, and a plurality of vehicles (including vehicles 200A to 200D, which will be described later). The electricity supply system 1A includes roads 500A and 500B, and parking lots St1 to St7. The roads 500A and 500B intersect at an intersection P10. The parking lots St1 to St4 are adjacent to the road 500A. The parking lots St5 to St7 are adjacent to the road 500B. Each of the parking lots St1 to St7 includes at least one piece of electricity supply equipment (more specifically, EVSE).

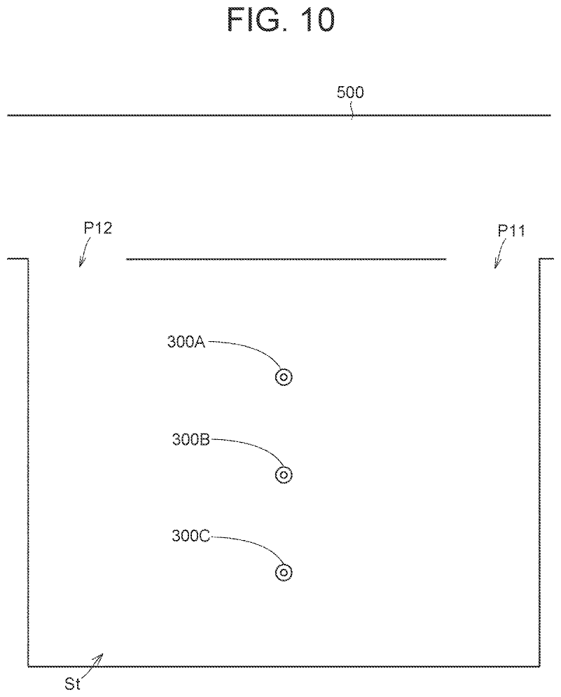

When the roads included in the electricity supply system 1A are not distinguished from each other, each road is referred to as “road 500”. Moreover, when the parking lots included in the electricity supply system 1A are not distinguished from each other, each parking lot is referred to as “parking lot St”. For example, the parking lot St has a configuration shown in FIG. 10. FIG. 10 is a plane view showing the configuration of the parking lot St. Referring to FIG. 10, the parking lot St includes EVSEs 300A to 300C. Each of the EVSEs 300A to 300C has the same configuration as the EVSE 300 shown in FIGS. 1 and 2, and performs the processing shown in FIG. 4. The parking lot St corresponds to a charging station for electrified vehicles. The parking lot St is adjacent to the road 500. The parking lot St has gateways P11 and P12 to and from the road 500.

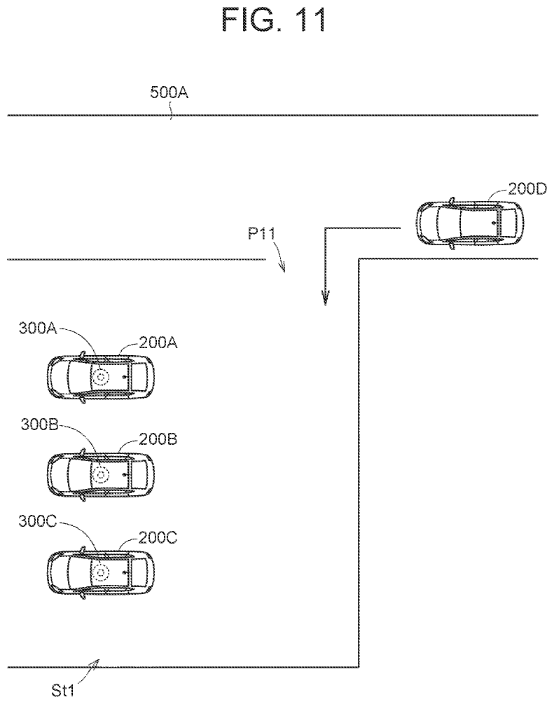

FIG. 11 is a diagram for describing operation of a target vehicle that intends to receive electricity supply at the parking lot St. Referring to FIG. 11, the vehicle 200D corresponds to the target vehicle. A traveling route and a traveling schedule are set on the vehicle 200D. The vehicle 200D performs driverless autonomous traveling on the road 500A toward a destination, according to the set traveling route and traveling schedule. For example, on a map shown in FIG. 9, the traveling route that starts from a position P1 (point of departure), passes through the parking lot St1 (way-stop point), and arrives at a position P2 (destination) is set on the vehicle 200D. The traveling schedule includes a time of arrival at the position P2 (destination). The vehicle 200D travels on the road 500A through automated driving such as to arrive at the position P2 (destination) by the time indicated in the set traveling schedule. The vehicle 200D travels on the road 500A from the position P1, heading for the position P2, and stops over at the parking lot St1 on the way to receive electricity supply at the parking lot St1.

In the example shown in FIG. 11, the vehicle 200D travels on the road 500A and arrives at the parking lot St1. When the vehicle 200D enters the parking lot St1 from the gateway P11, all electricity supply equipment included in the parking lot St1 are being used by vehicles other than the vehicle 200D (target vehicle). The EVSEs 300A, 300B, 300C are being used by the vehicles 200A, 200B, 200C, respectively. Each of the vehicles 200A to 200D has the same configuration as the vehicle 200 shown in FIGS. 1 and 2.

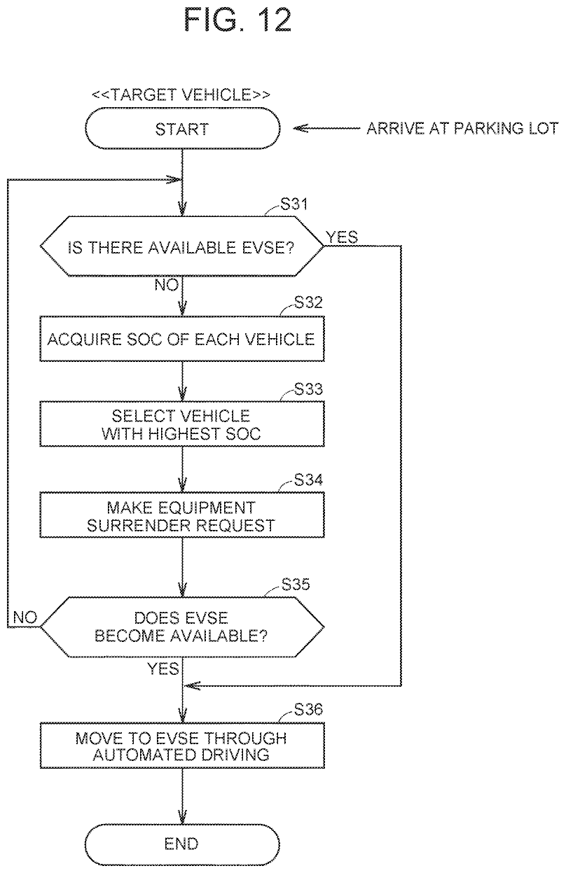

The vehicle 200D performs processing shown in FIG. 12, which is described below, when entering the parking lot St1. FIG. 12 is a flowchart showing the processing performed when the target vehicle arrives at the parking lot St1. The processing shown in the flowchart is performed by the control device of the target vehicle. In the example shown in FIG. 11, the ECU 230 of the vehicle 200D corresponds to the control device of the target vehicle. The vehicle 200D enters the parking lot St1, is parked, and performs the processing shown in FIG. 12, which is described below.

Referring to FIG. 12 as well as FIGS. 1 and 11, in S31, the ECU 230 of the vehicle 200D determines whether or not there is available electricity supply equipment in the parking lot St1. In the example shown in FIG. 11, since all electricity supply equipment included in the parking lot St1 is being used, NO is determined in S31. Note that when any of the EVSEs 300A to 300C included in the parking lot St1 is in an available state, YES is determined in S31. In such a case, in S36, the vehicle 200D moves to the available EVSE through automated driving and is parked at the electricity supply position of the EVSE.

When NO is determined in S31, in S32, the ECU 230 of the vehicle 200D acquires the SOC of each vehicle (more specifically, the SOC of the battery 210 mounted on each vehicle) that is using the electricity supply equipment in the parking lot St1 through vehicle-to-vehicle communication, and in S33, selects a vehicle with the highest SOC. As described above, the vehicle 200D (target vehicle) is configured to preferentially select a vehicle with the higher-SOC battery 210 (electricity storage device) when selecting a vehicle to be requested to surrender the electricity supply equipment in S34, which will be described later, from among the vehicles 200A to 200C that are being supplied with electricity in the parking lot St1. According to such a configuration, traveling of a vehicle with the lower-SOC battery 210 is restrained, so that vehicles running out of electricity are less likely to exist.

For example, when the vehicle with the highest SOC among the vehicles 200A to 200C that are using the electricity supply equipment in the parking lot St1 is the vehicle 200B, the vehicle 200B is selected in S33. The fact that the vehicle 200B is selected from among the vehicles 200A to 200C means that the EVSE 300B is selected from among the EVSEs 300A to 300C. Hereinafter, a case where the vehicle 200B is selected in S33 is described, as an example.

In S34, the ECU 230 of the vehicle 200D makes an equipment surrender request to the vehicle 200B (the vehicle selected in S33) through vehicle-to-vehicle communication. With the equipment surrender request, the vehicle 200B is requested to surrender the EVSE 300B (currently used electricity supply equipment).

Thereafter, in S35, the ECU 230 of the vehicle 200D determines whether or not the EVSE 300B (the equipment targeted by the equipment surrender request) becomes available. When the vehicle 200B leaves the EVSE 300B in response to the equipment surrender request (YES in S35), the processing advances to S36. When the vehicle 200B does not respond to the equipment surrender request (NO in S35), the processing returns to S31. The ECU 230 of the vehicle 200D continues to make an equipment surrender request (S34) until any one of the EVSEs 300A to 300C included in the parking lot St1 becomes available.

In S36, the vehicle 200D moves to the electricity supply equipment (any one of the EVSEs 300A to 300C) that becomes available through automated driving. When the vehicle 200D is parked at the electricity supply position of any one of the EVSEs 300A to 300C, the EVSE starts supplying electricity to the vehicle 200D through the processing shown in FIG. 4. Through the electricity supply, the vehicle 200D can store electricity for traveling according to the set traveling route in the battery 210.

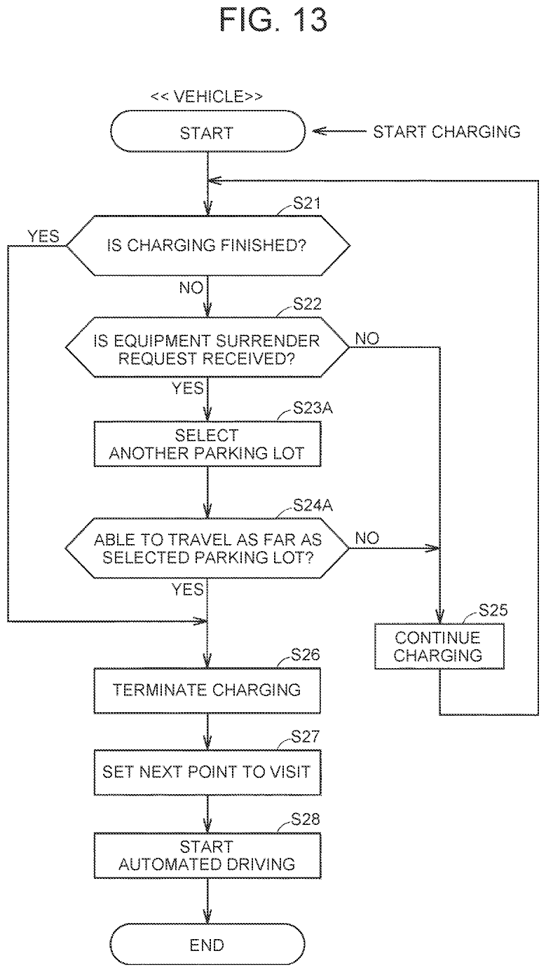

FIG. 13 is a flowchart showing processing performed by a vehicle (vehicle other than the target vehicle) being supplied with electricity from electricity supply equipment. The processing shown in the flowchart is performed by the control device of each vehicle that is being supplied with electricity from EVSE in the parking lot St included in the electricity supply system 1A. Hereinafter, the processing shown in FIG. 13 is described by taking a case, as an example, where the ECU 230 of the vehicle 200B performs the processing shown in FIG. 13. For example, when the vehicle 200B starts using the EVSE 300B in the parking lot St1 shown in FIG. 11, the processing shown in FIG. 13 is started.

The processing shown in FIG. 13 is the same as the processing shown in FIG. 7, except that S23A, S24A are adopted instead of S23, S24 (FIG. 7). Hereinafter, S23A and S24A are described.

Referring to FIG. 13 as well as FIGS. 1, 9, and 11, in S23A, the ECU 230 of the vehicle 200B selects one parking lot from among the plurality of parking lots included in the electricity supply system 1A. The parking lot selected in S23A is a parking lot other than the parking lot St1 (the parking lot where the vehicle 200B is currently present), and is set as a next point for the vehicle 200B to visit through a process (S27), which will be described later. In S23A, the ECU 230 of the vehicle 200B selects, for example, a parking lot that is located on a closer side to the destination than the parking lot St1 along the traveling route set on the vehicle 200B, and is the closest to the parking lot St1, among the plurality of parking lots included in the electricity supply system 1A. For example, on the map shown in FIG. 9, when the traveling route that starts from the position P1 (point of departure), passes through the parking lot St1 (way-stop point), and arrives at a position P3 (destination) is set on the vehicle 200B, the parking lot St2 may be selected in S23A. However, the method is not limited to this, and any method may be used for selecting a parking lot in S23A.

In S24A, the ECU 230 of the vehicle 200B determines, based on a distance to empty of the vehicle 200B, whether or not the vehicle 200B can travel as far as the parking lot selected in S23A. When YES is determined in S24A, in S26, the ECU 230 of the vehicle 200B terminates charging of the battery 210 using the EVSE 300B, and in S27, sets the parking lot selected in S23A as a next point for the vehicle 200B to visit. In S28, the vehicle 200B departs toward the next point to visit (for example, the parking lot St2) through automated driving.

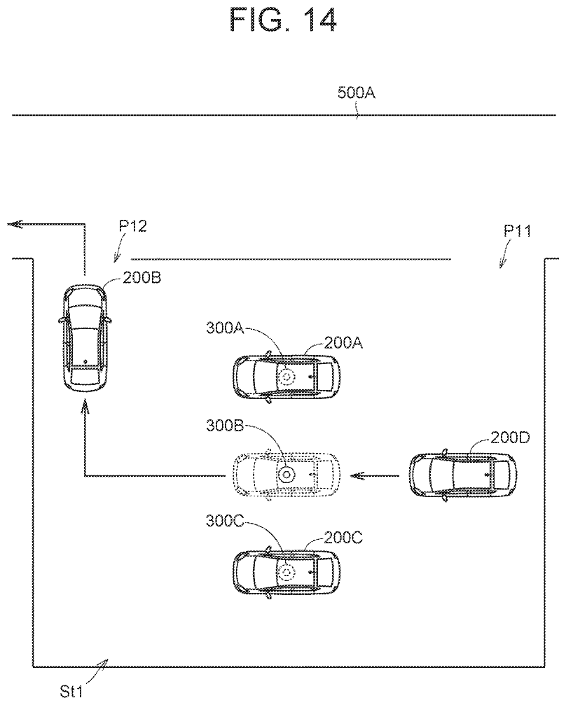

FIG. 14 is a diagram for describing operation of each vehicle included in the electricity supply system 1A. Hereinafter, operation of another vehicle that has received an equipment surrender request from the target vehicle is described by using FIGS. 1, 2, and 11 to 14.

For example, when the vehicle 200D (target vehicle) intends to receive electricity supply at the parking lot St1 (first parking lot) and all electricity supply equipment (EVSEs 300A to 300C) included in the parking lot St1 is being used by other vehicles as shown in FIG. 11, the vehicle 200D selects one vehicle from among the vehicles 200A to 200C that are being supplied with electricity in the parking lot St1 (S33 in FIG. 12). For example, the vehicle 200D selects a vehicle with the highest SOC. In the example shown in FIG. 14, the vehicle 200B is selected. The vehicle 200D then requests the selected vehicle 200B to surrender the EVSE 300B that the vehicle 200B is using (S34 in FIG. 12). The vehicle 200B requested to surrender the EVSE 300B selects a second parking lot from among the plurality of parking lots included in the electricity supply system 1A (S23A in FIG. 13). When the vehicle 200B can travel as far as the selected second parking lot (YES in S24A in FIG. 13), the vehicle 200B surrenders the currently used EVSE 300B to the vehicle 200D and moves to the second parking lot through automated driving (S28 in FIG. 13). Thereafter, the vehicle 200D is parked at the electricity supply position of the EVSE 300B and receives electricity supply from the EVSE 300B. The vehicle 200D starts using the EVSE 300B and performs the processing shown in FIG. 13.

As described above, in the electricity supply system 1A according to the second embodiment, another vehicle that has received an equipment surrender request from the target vehicle surrenders electricity supply equipment in the first parking lot to the target vehicle and moves to the second parking lot. Thus, a wait time of the target vehicle is shortened, and the target vehicle is restrained from being excessively behind the planned traveling schedule.

### OTHER EMBODIMENTS

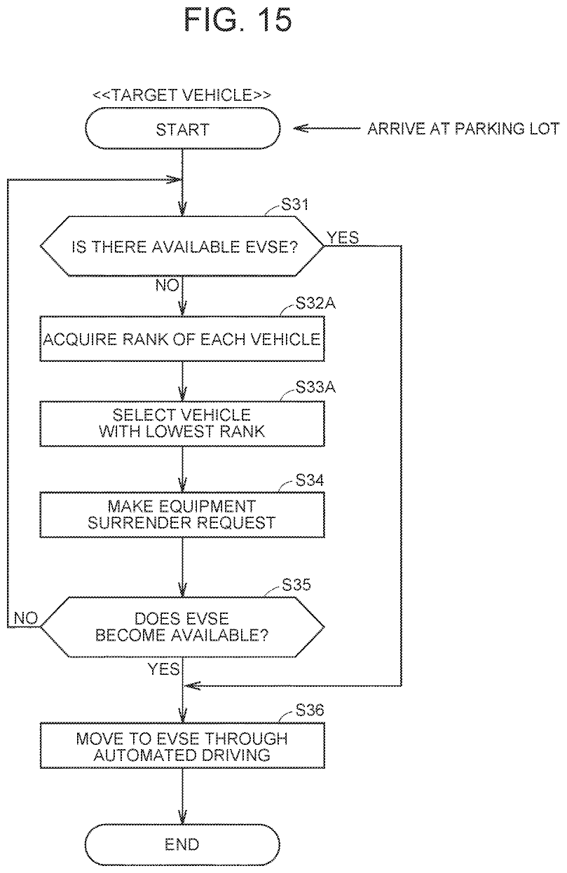

Each of a plurality of vehicles included in an electricity supply system may be ranked. For example, each vehicle included in the electricity supply system 1A according to the second embodiment may be ranked. Each vehicle included in the electricity supply system 1A may perform processing shown in FIG. 15, which is described below, instead of the processing shown in FIG. 12 when entering a parking lot to receive electricity supply. FIG. 15 is a flowchart showing a modification of the processing shown in FIG. 12.

In the modification, each vehicle included in the electricity supply system 1A is an automated driving vehicle configured to be capable of driverless traveling according to a predetermined traveling schedule, and has the same configuration as the vehicle 200 shown in FIGS. 1 and 2. Each vehicle is ranked according to a predetermined rule and has an own rank. The rank is stored in the storage device of the ECU 230 (FIG. 1). An arbitrary method may be used for setting the rank. For example, each vehicle may be ranked based on a type and a state of the vehicle. The ECU 230 may update the rank, depending on a state of the vehicle. Specifically, the rank of an emergency vehicle (for example, a vehicle for medical care or disaster control) may be set higher than the ranks of ordinary vehicles (vehicles other than the emergency vehicle). The rank of a robotaxi carrying a passenger may be set higher than the rank of a robotaxi carrying no passenger. The rank of a vehicle having a longer distance to travel to the destination may be set higher. The rank of a vehicle that is more greatly behind the set traveling schedule may be set higher.

The processing shown in FIG. 15 is the same as the processing shown in FIG. 12, except that S32A, S33A are adopted instead of S32, S33 (FIG. 12). Hereinafter, S32A and S33A are described.

In S32A, the ECU 230 of the target vehicle acquires the rank of each vehicle that is using the electricity supply equipment in the parking lot St1 through vehicle-to-vehicle communication, and in S33A, selects a vehicle with the lowest rank. As described above, the target vehicle is configured to preferentially select a vehicle with a lower rank when selecting a vehicle to be requested to surrender the electricity supply equipment in S34 from among the plurality of vehicles that are being supplied with electricity in the parking lot St1. With such a configuration, disruption to traveling of a vehicle with a higher rank can be restrained.

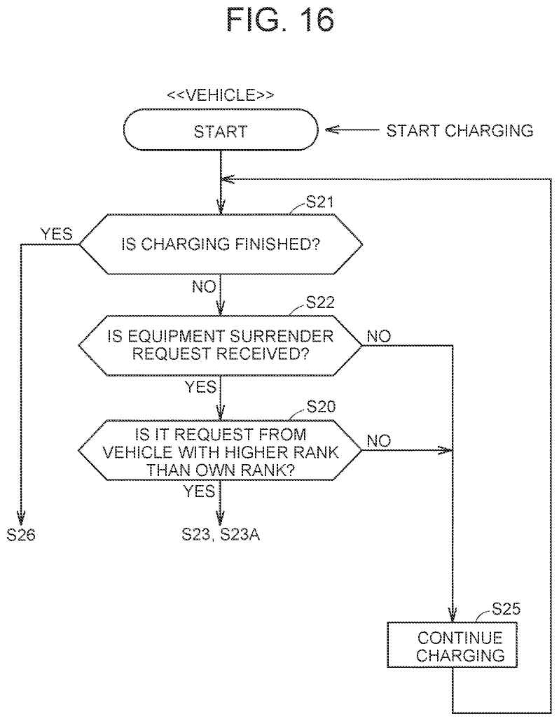

The processing shown in each of FIGS. 7 and 13 may be modified as shown in FIG. 16. FIG. 16 is a flowchart showing the modification of the processing shown in each of FIGS. 7 and 13. In the modification described below, each vehicle included in an electricity supply system is also ranked according to a predetermined rule and has an own rank, as in the modification shown in FIG. 15.

In the processing shown in FIG. 16, S20 is added to the processing shown in FIG. 7 or 13. When the modification shown in FIG. 16 is applied to the processing shown in FIG. 7, S20 is interposed between S22 and S23. When the modification shown in FIG. 16 is applied to the processing shown in FIG. 13, S20 is interposed between S22 and S23A. Hereinafter, S20 is described.

In S20, a vehicle that has received an equipment surrender request compares the own rank of the vehicle and the rank of a vehicle that has transmitted the equipment surrender request. The vehicles may check the rank of each other through vehicle-to-vehicle communication. When the rank of the vehicle that has transmitted the equipment surrender request is higher than the rank of the vehicle that has received the equipment surrender request (YES in S20), the processing advances to S23 or S23A. When the processing advances to S23 or S23A, the vehicle that has received the equipment surrender request surrenders the electricity supply equipment in response to the equipment surrender request if the vehicle can travel as far as the second electricity supply equipment or the second parking lot. When the rank of the vehicle that has transmitted the equipment surrender request is not higher than the rank of the vehicle that has received the equipment surrender request (NO in S20), the processing returns to S21 via S25. The fact that the processing advances to S25 means that the vehicle that has received the equipment surrender request refuses the equipment surrender request and continues charging.

The process in S20 corresponds to a process of determining whether or not a predetermined refusal condition is met. In the example shown in FIG. 16, the predetermined refusal condition is met when the rank of the vehicle that has transmitted the equipment surrender request is not higher than the rank of the vehicle that has received the equipment surrender request. However, the condition is not limited to such a condition, and the predetermined refusal condition can be changed as appropriate. For example, the predetermined refusal condition may be met when the SOC of the vehicle that has received the equipment surrender request is lower than a predetermined value. The predetermined refusal condition may be met when the SOC of the vehicle that has transmitted the equipment surrender request is higher than the SOC of the vehicle that has received the equipment surrender request.

In each of the embodiments and the modifications, information is exchanged between vehicles through vehicle-to-vehicle communication. However, the scheme is not limited to such a scheme, and the electricity supply system may include at least one of a server that manages a plurality of registered vehicles, and a server that manages a plurality of registered electricity supply equipment. A single server may manage both vehicles and electricity supply equipment as management targets. The server may receive information (for example, a state) from a management target, and may transmit information (for example, an instruction) to a management target. Exchange of information between management targets (for example, between vehicles, between electricity supply equipment, or between a vehicle and electricity supply equipment) may be performed via the server.

A configuration of underground electricity supply equipment is not limited to the configuration shown in FIGS. 1 and 2. For example, the shape, the size, and the like of the casing can be changed as appropriate. Moreover, the shape, the size, and the like of the movable part can also be changed as appropriate. A place of installation of underground electricity supply equipment is not limited to the above-described places (see FIGS. 5, 9, and 10), and can also be changed as appropriate. Since underground electricity supply equipment is in the housed state (for example, the state shown in FIG. 1) when unused, underground electricity supply equipment does not spoil a sight even if installed in a city or a town. An electricity supply system may include electricity supply equipment other than underground electricity supply equipment in place of, or in addition to, the underground electricity supply equipment. An electricity supply system may include arm electricity supply equipment that is configured to be able to automatically plug in and plug out without user operation. For example, an arm of such electricity supply equipment may be driven by a motor. An electricity supply system may include non-contact (wireless) electricity supply equipment.

A configuration of a vehicle is not limited to the configuration shown in FIGS. 1 and 2 either. For example, a vehicle may be configured to be chargeable with direct-current (DC) electricity. Electricity supply equipment may be DC electricity supply equipment. The electricity conversion circuit of the charger 212 may be mounted not on a vehicle but on electricity supply equipment.

A vehicle is not limited to an EV, but may be a plug-in hybrid electric vehicle (PHEV). Note that the distance to empty of a PHEV (S24 in FIG. 7 and S24A in FIG. 13) is calculated by taking into consideration not only remaining electricity in the electricity storage device but also remaining fuel for an internal combustion engine. A vehicle is not limited to a passenger car, but may be a bus or a truck. A vehicle may include a flight function.

The various modifications as described above may be arbitrarily combined and executed. The embodiments in the present disclosure are disclosed for illustrative purposes in all respects, and should not be construed as imposing limitations. The scope of the present disclosure is indicated not by the description of the embodiments but by claims, and intends to include meanings equivalent to the claims and all changes made within the scope of the claims.

What is claimed is:

1. An electricity supply system comprising:
a plurality of pieces of electricity supply equipment; and
a plurality of vehicles including a first vehicle and a second vehicle,
wherein when the second vehicle being supplied with electricity from first electricity supply equipment included in the plurality of pieces of electricity supply equipment receives a request to surrender the first electricity supply equipment from the first vehicle, the second vehicle surrenders the first electricity supply equipment to the first vehicle and moves, through automated driving, to second electricity supply equipment selected from among the plurality of pieces of electricity supply equipment when the second vehicle is able to travel as far as the second electricity supply equipment.

2. The electricity supply system according to claim 1, wherein each of the first vehicle and the second vehicle is an automated driving vehicle configured to be capable of driverless traveling according to a predetermined traveling schedule.

3. The electricity supply system according to claim 1, wherein:
each of the first vehicle and the second vehicle includes an electricity storage device that is chargeable with electricity externally supplied, and is configured to travel by using the electricity stored in the electricity storage device; and
the first vehicle acquires state of charge (SOC) of the electricity storage device of the second vehicle and, when the SOC of the electricity storage device of the second vehicle is higher than SOC of the electricity storage device of the first vehicle, requests the second vehicle to surrender the first electricity supply equipment.

4. The electricity supply system according to claim 3, wherein the first vehicle acquires the SOC of the electricity storage device of the second vehicle from the second vehicle through vehicle-to-vehicle communication, and requests the second vehicle to surrender the first electricity supply equipment through vehicle-to-vehicle communication.

5. The electricity supply system according to claim 1, wherein when a traveling route is set on the second vehicle, the second vehicle selects, as the second electricity supply equipment, electricity supply equipment on the traveling route among the plurality of pieces of electricity supply equipment.

6. The electricity supply system according to claim 1, wherein the second vehicle refuses the request from the first vehicle when a predetermined refusal condition is met.

7. The electricity supply system according to claim 1, wherein:
each of the first electricity supply equipment and the second electricity supply equipment includes
a movable part including a plug configured to be connectable to an inlet of each vehicle,
an actuator that moves the movable part,
an electricity supply circuit that supplies electricity to the plug, and
a control device that controls the actuator and the electricity supply circuit;
the movable part is configured to be displaced within a range of movement including a first position in which the plug is housed under a ground surface, and a second position in which the plug is exposed above the ground surface; and
the control device causes electricity supply to be performed in a state where the movable part is in the second position and, when the electricity supply is finished, displaces the movable part into the first position.

8. The electricity supply system according to claim 7, wherein each of the first electricity supply equipment and the second electricity supply equipment is installed in a road and is configured to perform electricity supply to a vehicle parked on the road.

9. An electricity supply system comprising:
a plurality of parking lots; and
a plurality of vehicles, wherein
each of the plurality of parking lots includes at least one piece of electricity supply equipment,
among the plurality of vehicles, a target vehicle that intends to receive electricity supply at a first parking lot included in the plurality of parking lots selects one vehicle from among other vehicles being supplied with electricity in the first parking lot and requests the selected vehicle to surrender electricity supply equipment currently used by the selected vehicle when all electricity supply equipment included in the first parking lot is used by the other vehicles, and
the vehicle requested to surrender the electricity supply equipment surrenders the currently used electricity supply equipment to the target vehicle and moves, through automated driving, to a second parking lot selected from among the plurality of parking lots when the requested vehicle is able to travel as far as the second parking lot.

10. The electricity supply system according to claim 9, wherein:
each of the plurality of vehicles includes an electricity storage device that is chargeable with electricity externally supplied, and is configured to travel by using the electricity stored in the electricity storage device; and
the target vehicle preferentially selects a vehicle with the electricity storage device having higher state of charge (SOC) when selecting a vehicle to be requested to surrender the currently used electricity supply equipment from among the other vehicles being supplied with electricity in the first parking lot.

11. The electricity supply system according to claim 9, wherein:
each of the plurality of vehicles is ranked; and
the target vehicle preferentially selects a vehicle with a lower rank when selecting a vehicle to be requested to surrender the currently used electricity supply equipment from among the other vehicles being supplied with electricity in the first parking lot.

12. An electricity supply method comprising:
by a first vehicle, requesting a second vehicle being supplied with electricity from first electricity supply equipment to surrender the first electricity supply equipment;
by the second vehicle, when the second vehicle is requested by the first vehicle to surrender the first electricity supply equipment, determining whether or not the second vehicle is able to travel from the first electricity supply equipment to second electricity supply equipment; and
by the second vehicle, when it is determined, in the determining, that the second vehicle is able to travel, moving from the first electricity supply equipment to the second electricity supply equipment through automated driving.
